(19) United States
(12) Patent Application Publication
(10) Pub. No.: US 2004/0267883 A1
(43) Pub. Date: Dec. 30, 2004

(54) Repository for a mobile telephone

(75) Inventors: Jan Chipchase, (US); Per Persson, (US); Petri Piippo, (US); Tetsuya Yamamoto, (US); Mikko Aarras, (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/608,173

(22) Filed: Jun. 27, 2003

(51) Int. Cl. H04B 7/00

(52) U.S. Cl. 709/206; 340/825.37

(57) ABSTRACT

A repository, for a plurality of objects, comprising:

a body for supporting simultaneously a plurality of objects including a mobile phone and at least one other object;

wireless communication means for communicating with at least one of the plurality of objects; and

a user interface responsive to the wireless communication means for providing information to a user.

### FIELD OF THE INVENTION

Embodiments of the invention relate to repositories for a mobile telephones.

### BACKGROUND TO THE INVENTION

People use different strategies to enable them to remember which objects to take with them when they leave home or work. The common strategy is to leave objects clustered around a single point close to the entrance/exit of an environment. For example, objects such as keys, a wallet and a mobile cellular telephone are often left close to the front door of the person's home. However, the mobile cellular telephone is generally recharged elsewhere as the charger and its cabling is generally unsightly. As a result, mobile cellular telephones are often left behind when the person leaves that environment.

### BRIEF DESCRIPTION OF THE DRAWINGS

Embodiments of the invention will now be described by way of example, with reference to the accompany drawings in which:

FIG. 1 is a perspective view of a repository, and

FIG. 2 is a schematic diagram of the operational components of the repository.

### DETAILED DESCRIPTION OF AN EMBODIMENT OF THE INVENTION

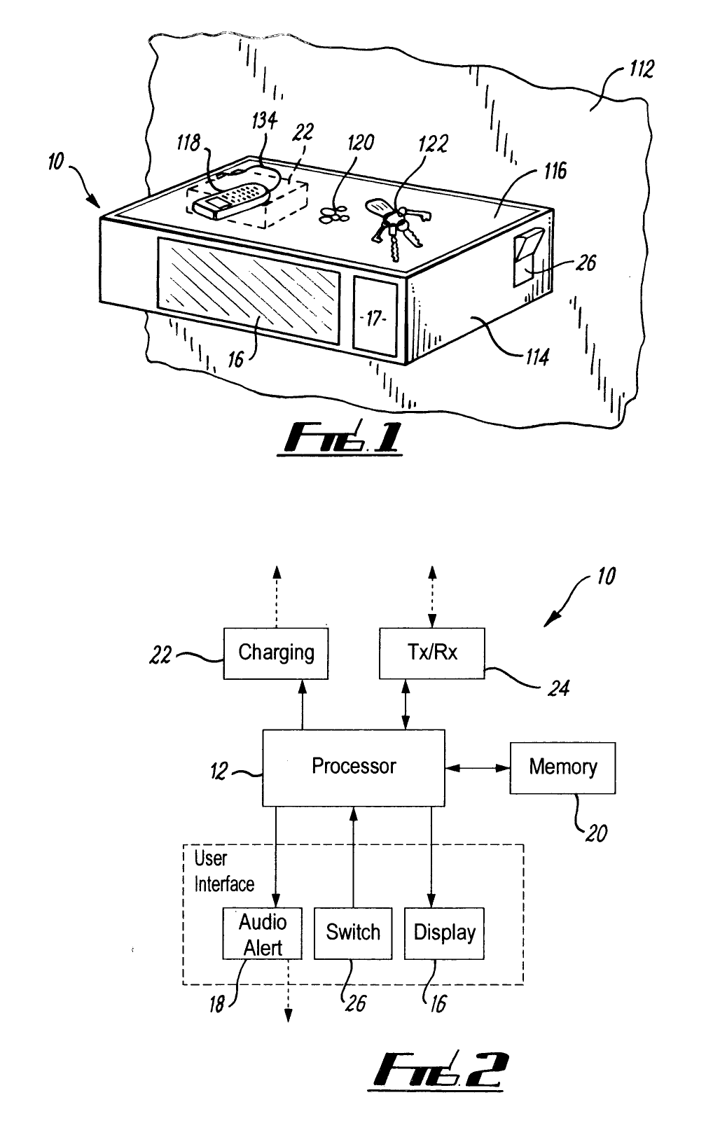

FIG. 1 is a perspective view of a repository 10 and FIG. 2 is a schematic diagram of the operational components of the repository 10.

The repository 10 has, in this example, the form of a shelf which is attachable to a wall 112, or can be freestanding on another surface, such as a table. The repository may be powered from a mains power supply or using a fuel cell. The repository may be shaped as a shelf, a bowl, a box a tray etc. The repository comprises a main body 114 and an upwardly facing, substantially planar support surface 116. The body 114 may have a transparent presentational portion 17, behind which a user can slide images and photographs. This allows a user to quickly and cheaply personalise the repository 10.

The support surface 116 is of a suitable size to support a mobile phone and at least one further object. In FIG. 1, the support surface 16 is shown as supporting a mobile phone 118, coins 120 and a bunch of keys 122. Of course, it will be appreciated that the repository can be used to support other items in addition to, or instead of the coins 120 and the keys 122, for example, a wallet or purse.

Referring to FIG. 2, the repository 10 comprises: a processor 12; a user interface including a display 16, an audio alert 18 and an on/off switch 26.; a memory 20; charging circuitry 22; and communication circuitry 24.

The processor 12 writes to and reads from memory 20 and receives inputs from the communication circuitry 24.

The communications circuitry 24 operates as a proximity sensor that senses the objects near to or on the support surface 116, and as a data transfer mechanism that transfers data from a nearby object to the repository 10.

The communications circuitry 24 may include a low power radio frequency transceiver (e.g. Bluetooth). The LPRF transceiver is capable of operating as a proximity sensor as it is able to detect a corresponding LPRF transceiver that is within its range. The LPRF transceiver is capable of operating as a data transfer mechanism as it is able to receive data from a corresponding LPRF transceiver that is within its range. The corresponding LPRF transceiver may, for example, be integrated in the mobile cellular telephone 118.

The communications circuitry may include a mechanism that enables the proximity detection of objects that do not have LPRF transceivers. For example, the communications circuitry may include RFID detector. Such a detector can be used to identify an object near or on the support surface 116 if the object is tagged with an identifying RFID tag.

The processor 12 is able to determine from the input received from the communications circuitry 24 when a new object is near to or placed on the support surface, when an object is moved away from the support surface, and the identities of the objects on or near the support surface 116 at any time.

The communication circuitry 24 detects nearby objects and provides a channel via which data may be transferred from a suitable object, that is nearby, to the memory 20 of the repository 10. For example, calendar appointments and reminders stored in the mobile telephone 118 may be transferred automatically, without user involvement, from the mobile telephone 118 to the memory 20 via the communications circuitry 24 and the processor 12. The transfer may take place automatically whenever the mobile cellular telephone 10 comes with range of the LPRF communications circuitry 24. Images captured by a camera enabled mobile telephone 118 may also be transferred to the memory 20 via the communications circuitry 24.

The processor 12 is connected to control each of the charging circuitry 22, the display 16 and the audio alert 18.

The audio alert 18 is any suitable audio output device, such as a loudspeaker. It is activated by the processor 12, whenever it is necessary to draw a user's attention to the repository 10. The audio alert 18 is optional.

The alert may for example be activated when a calendar appointment or reminder becomes due or there is less than a certain period of time before it is due. This ‘reminder’ activation may be conditional on the removal of one or more objects from the support surface 116, such as the removal of the user's car keys 122 and/or the user's mobile telephone 118.

The alert may for example be activated when an object is removed from the support surface 116 while another object is left behind. For example, the alert may be activated when a user's car keys or house keys 122 are removed from the support surface 116 while the user's mobile cellular telephone 118 remains on the support surface 116.

The display 16 is controlled by the processor 12 to present information to the user. The processor 12, may for example, display an icon for each of the objects present on the support surface 116. The processor 12, may display up-and-coming calendar appointments and reminders which have been previously received from an object and stored in memory 20. The processor 12 may control the display of an image recently received from an object.

The charging circuitry 22 is controlled by the processor 12 to recharge a device, such as the mobile cellular telephone 118, placed on the support surface 116. The charging circuitry 22 may include a retractable cable 134 that is extendible from the support arrangement 10 for connection to the mobile cellular telephone 118. Alternatively, the charging circuitry 22 may charge the mobile telephone wirelessly using inductive charging. In this case, the mobile cellular telephone 118 should be positioned in a predetermined location on the support surface near the inductive charging circuitry 22. The repository 10 can also be provided with an on/off switch 26. The repository 10 can be powered by mains power or, alternatively, by a fuel cell.

Although embodiments of the present invention have been described in the preceding paragraphs with reference to various examples, it should be appreciated that modifications to the examples given can be made without departing from the spirit and scope of the invention. For example, a button may be provided on the repository that activates the communications circuitry and causes it to communicated with a selected or particular device, such as a mobile telephone, and causes it to sound its alert, so that it can, for example, be easily located. The repository may be programmed with a reminder that will be triggered for someone else who shares the same environment. For example, a user may set a reminder for his girlfriend which is activated when his girlfriend's telephone comes within range of the communications circuitry of the repository.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A repository, for a plurality of objects, comprising:
a body for supporting simultaneously a plurality of objects including a mobile phone and at least one other object;
wireless communication means for communicating with at least one of the plurality of objects; and
a user interface responsive to the wireless communication means for providing information to a user.

2. A repository as claimed in claim 1, wherein the wireless communication means is arranged to detect proximal objects by communication therewith.

3. A repository as claimed in claim 2, wherein the wireless communication means comprises a LPRF transceiver.

4. A repository as claimed in claim 2, wherein the wireless communication means comprises an RFID detector.

5. A repository as claimed in claim 1, wherein the wireless communication means transfers data from an object.

6. A repository as claimed in claim 5, wherein the wireless communication means comprises a LPRF transceiver.

7. A repository as claimed in claim 1, wherein the wireless communication means comprises a LPRF transceiver for detecting proximal objects by communication therewith and for transferring data from a proximal object.

8. A repository as claimed in claim 7, further comprising a memory; and a processor for controlling a display of the user interface to display the transferred data.

9. A repository as claimed in claim 1 in the form of a shelf.

10. A repository according to claim 1, having a substantially planer support surface.

11. A repository according to claim 1 comprising a display for displaying information received from the mobile phone.

12. A repository as claimed in claim 1, wherein the wireless communication means identifies an object that has been removed from the repository.

13. A repository as claimed in claim 12, further comprising a processor responsive to the communication means for activating an alert in the user interface.

14. A repository as claimed in claim 13, wherein the processor is arranged to activate the alert when a first object has been removed from the repository but a second object has not been removed.

15. A repository as claimed in claim 13, wherein the processor is arranged to activate the alert in dependence upon data transferred via the communication means to the repository and the removal of a first object from the repository.

16. A repository comprising: a body having a support surface for supporting simultaneously a plurality of objects including a mobile telephone and at least one other object, and charging circuitry, within the body, for recharging a mobile telephone.
